(19) United States
(12) Patent Application Publication
(10) Pub. No.: US 2009/0291833 A1
(43) Pub. Date: Nov. 26, 2009

(54) HONEYCOMB STRUCTURE

(75) Inventors: Kazushige OHNO, Ibi-Gun (JP); Masafumi KUNIEDA, Ibi-Gun (JP); Takahiko IDO, Ibi-Gun (JP)

Correspondence Address: DITTHAVONG MORI & STEINER, P.C., 918 Prince St., Alexandria, VA, 22314, US

(73) Assignee: IBIDEN CO., LTD., Ogaki-Shi (JP)

(21) Appl. No.: 12/495,762

(22) Filed: Jun. 30, 2009

Related U.S. Application Data
(63) Continuation of application No. PCT/JP2008/059281, filed on May 20, 2008.

(51) Int. Cl. B01J 29/06; B01J 29/072; B01J 29/08; B01J 29/18; B01J 29/40

(52) U.S. Cl. 502/65; 502/66; 502/67

(57) ABSTRACT

A honeycomb structure includes center and peripheral regions. The center region has a smaller similarity shape in relation to a peripheral shape of the honeycomb structure in a cross section perpendicular to the longitudinal direction. The peripheral region is located outside the smaller similarity shape. Zeolite ion-exchanged with at least one of Cu, Mn, Ag, and V is present at a first weight ratio and a second weight ratio in the center region and the peripheral region, respectively, relative to a total weight of the zeolite. The second weight ratio is larger than the first weight ratio. Zeolite ion-exchanged with at least one of Fe, Ti, and Co is present at a third weight ratio and a fourth weight ratio in the center region and the peripheral region, respectively, relative to a total weight of the zeolite. The third weight ratio is larger than the fourth weight ratio.

### CROSS-REFERENCE TO RELATED APPLICATIONS

The present application is a continuation application of International Application No. PCT/JP2008/059281 filed on May 20, 2008, the entire contents of which are incorporated by reference herein.

### BACKGROUND OF THE INVENTION

1. Field of the Invention

The present invention relates to honeycomb structures.

2. Discussion of Background

Conventionally, as a system for converting exhaust gases from automobiles, a SCR (Selective Catalytic Reduction) system in which NOx is reduced to nitrogen and water using ammonia has been known (see below).

4NO+4NH₃+O₂→4N₂+6H₂O

6NO₂+8NH₃→7N₂+12H₂O

NO+NO₂+2NH₃→2N₂+3H₂O

In the SCR system, zeolite is known as a material for absorbing ammonia.

JP-A-9-103653 discloses a method for converting NOx into innocuous products which involves providing an iron-ZSM-5 monolithic structure zeolite having a silica to alumina mole ratio of at least about 10, wherein the content of the iron is about 1 through 5% by weight, and contacting the zeolite with a NOx-containing process stream in the presence of ammonia at a temperature of at least about 200° C.

Furthermore, International Publication No. 06/137149 discloses a honeycomb structure having a honeycomb unit that contains inorganic particles, inorganic fibers, and/or whiskers, wherein the inorganic particles include one or more kinds selected from the group consisting of alumina, silica, zirconia, titania, ceria, mullite, and zeolite.

However, the honeycomb structure, which is obtained by extrusion-molding a material using zeolite ion-exchanged with Fe as a main raw material, is low in strength. When fine zeolite is used, or when inorganic particles other than zeolite and inorganic fibers are added to a material for extrusion molding so as to improve the strength of such a honeycomb structure, the honeycomb structure contains a bunch of fine particles, which in turn causes many grain boundaries and reduced thermal conductivity. Therefore, when such a honeycomb structure is applied to the SCR system in which NOx is reduced to nitrogen and water using ammonia, a temperature difference between the central part and the peripheral part of the honeycomb structure caused when exhaust gas flows becomes large as compared with a cordierite substrate. As a result, a region whose temperature is insufficient for the NOx conversion performance of the zeolite ion-exchanged with Fe is caused in the honeycomb structure, so that the NOx conversion ratio of the honeycomb structure becomes insufficient.

The contents of JP-A-9-103653 and International Publication No. 06/137149 are incorporated by reference herein.

### SUMMARY OF THE INVENTION

According to an aspect of the present invention, a honeycomb structure includes at least one honeycomb unit having a longitudinal direction and including walls extending along the longitudinal direction to define through-holes. The honeycomb structure includes a center region, a peripheral region, an inorganic binder, zeolite ion-exchanged with at least one of Cu, Mn, Ag, and V, and zeolite ion-exchanged with at least one of Fe, Ti, and Co. The center region has a smaller similarity shape in relation to a peripheral shape of the honeycomb structure in a cross section perpendicular to the longitudinal direction. The smaller similarity shape is defined by including a center of the honeycomb structure and substantially a half of a length from the center to the peripheral shape of the honeycomb structure. The peripheral region is located outside the smaller similarity shape. The zeolite ion-exchanged with at least one of Cu, Mn, Ag, and V is present at a first weight ratio and at a second weight ratio in the center region and in the peripheral region, respectively, relative to a total weight of the zeolite. The second weight ratio is larger than the first weight ratio. The zeolite ion-exchanged with at least one of Fe, Ti, and Co is present at a third weight ratio and at a fourth weight ratio in the center region and in the peripheral region, respectively, relative to a total weight of the zeolite. The third weight ratio is larger than the fourth weight ratio.

### BRIEF DESCRIPTION OF THE DRAWINGS

Other objects, features and advantages of the present invention will become more apparent from the following detailed description when read in conjunction with the accompanying drawings, in which:

FIG. 1A is a perspective view showing an example of a honeycomb structure according to an embodiment of the present invention;

FIG. 1B is the enlarged view of a cross section orthogonal to the longitudinal direction of the honeycomb structure shown in FIG. 1A;

FIG. 1C is a schematic view showing the cross section orthogonal to the longitudinal direction of the honeycomb structure shown in FIG. 1A;

FIG. 2A is a schematic view showing other example of the cross section orthogonal to the longitudinal direction of the honeycomb structure according to the embodiment of the present invention;

FIG. 2B is a schematic view showing still other example of the cross section orthogonal to the longitudinal direction of the honeycomb structure according to the embodiment of the present invention;

FIG. 3A is a perspective view showing other example of the honeycomb structure according to the embodiment of the present invention;

FIG. 3B is a perspective view showing a honeycomb unit shown in FIG. 3A; and

FIG. 4 is a diagram for explaining a method for measuring a NOx conversion ratio.

### DETAILED DESCRIPTION OF THE EMBODIMENTS

Embodiments will now be described with reference to the accompanying drawings, wherein like reference numerals designate corresponding or identical elements throughout the various drawings.

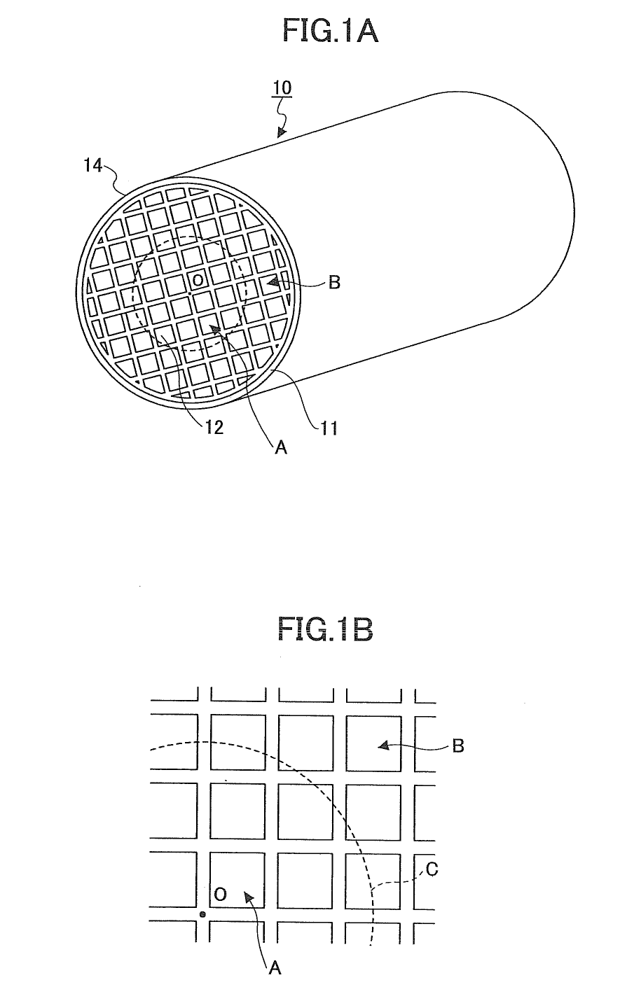

FIGS. 1A, 1B, and 1C show an example of a honeycomb structure according to the embodiment of the present invention. Note that FIGS. 1A, 1B, and 1C are a perspective view showing a honeycomb structure 10, an enlarged view showing a cross section orthogonal to the longitudinal direction of the honeycomb structure 10, and a schematic view showing the cross section orthogonal to the longitudinal direction of the honeycomb structure 10, respectively. The honeycomb structure 10 has a single honeycomb unit 11 containing zeolite and an inorganic binder and in which plural through-holes 12 are arranged side by side in the longitudinal direction through partition walls 12. In addition, a peripheral coating layer 14 is formed on the peripheral surface of the honeycomb unit 11. Here, the zeolite may include zeolite ion-exchanged with one or more kinds of metal selected from the group consisting of Cu, Mn, Ag, and V and zeolite ion-exchanged with one or more kinds of metal selected from the group consisting of Fe, Ti, and Co. In addition, the zeolite may further include zeolite not ion-exchanged and zeolite ion-exchanged with metals other than the above substances. When the honeycomb structure 10 excluding the peripheral coating layer 14, i.e., the cross section orthogonal to the longitudinal direction of the honeycomb unit 11 is divided into two equal parts at even intervals between the periphery and the center O of the cross section, a region B on the peripheral side is larger than a region A on the central side in the weight ratio of the zeolite ion-exchanged with one or more kinds of metal selected from the group consisting of Cu, Mn, Ag, and V relative to the total weight of the zeolite ion-exchanged with one or more kinds of metal selected from the group consisting of Cu, Mn, Ag, and V and the zeolite ion-exchanged with one or more kinds of metal selected from the group consisting of Fe, Ti, and Co. Moreover, the region A on the central side is larger than the region B on the peripheral side in the weight ratio of the zeolite ion-exchanged with one or more kinds of metal selected from the group consisting of Fe, Ti, and Co relative to the total weight of the zeolite ion-exchanged with one or more kinds of metal selected from the group consisting of Cu, Mn, Ag, and V and the zeolite ion-exchanged with one or more kinds of metal selected from the group consisting of Fe, Ti, and Co. Note that a boundary between the region A on the central side and the region B on the peripheral side is represented as a boundary line C.

Note that the honeycomb structure according to the embodiment of the present invention may have the peripheral coating layer formed at its peripheral surface. The region on the central side and the region on the peripheral side of the honeycomb structure are defined by a region other than the peripheral coating layer when the honeycomb structure has the peripheral coating layer, and they are defined by the honeycomb structure when the honeycomb structure does not have the peripheral coating layer.

A conventional honeycomb structure, which is obtained by extrusion-molding a material using zeolite ion-exchanged with Fe as a main raw material, tends to be low in strength. When fine zeolite is used, or when inorganic particles other than zeolite and inorganic fibers are added to a material for extrusion molding so as to improve the strength of such a conventional honeycomb structure, the honeycomb structure contains a bunch of fine particles, which in turn easily causes many grain boundaries and reduced thermal conductivity. Therefore, when such a honeycomb structure is applied to the SCR system in which NOx is reduced to nitrogen and water using ammonia, a temperature difference between the central part and the peripheral part of the honeycomb structure caused when exhaust gas flows easily becomes large as compared with a cordierite substrate. As a result, a region whose temperature is insufficient for the NOx conversion performance of the zeolite ion-exchanged with Fe is easily caused in the honeycomb structure, so that the NOx conversion ratio of the honeycomb structure easily becomes insufficient.

The embodiment of the present invention may provide a honeycomb structure capable of improving a NOx conversion ratio in a wide temperature range in a SCR system.

The present inventors have found that high NOx conversion performance is obtained in a wide temperature range when the zeolite ion-exchanged with one or more kinds of metal selected from the group consisting of Cu, Mn, Ag, and V is arranged at the peripheral part of the honeycomb structure 10 and the zeolite ion-exchanged with one or more kinds of metal selected from the group consisting of Fe, Ti, and Co is arranged at the central part of the honeycomb structure 10. This is because the zeolite ion-exchanged with one or more kinds of metal selected from the group consisting of Cu, Mn, Ag, and V has a higher NOx conversion performance in a low temperature range (e.g., between 150° C. and 200° C.) than the zeolite ion-exchanged with one or more kinds of metal selected from the group consisting of Fe, Ti, and Co. Therefore, when the honeycomb structure 10 is applied to a SCR system (in which NOx is reduced to nitrogen and water using ammonia), the zeolite in the honeycomb unit 11 can be easily effectively used for the conversion of NOx, and an NOx conversion ratio can be easily improved in a wide temperature range (e.g., between about 200° C. and about 500° C.).

Hereinafter, the honeycomb structure 10 is described in detail. The honeycomb unit 11 has the region A on the central side and the region B on the peripheral side via the boundary line C. The boundary line C is the line obtained by connecting the dots generated when line segments connecting the center O and the periphery of the cross section are divided into two equal parts at the cross section orthogonal to the longitudinal direction of the honeycomb unit 11. Therefore, the boundary line C is similar in shape to the periphery of the honeycomb unit 11.

Note that provided that the region B on the peripheral side is larger than the region A on the central side in the weight ratio of the zeolite ion-exchanged with one or more kinds of metal selected from the group consisting of Cu, Mn, Ag, and V relative to the total weight of the zeolite ion-exchanged with one or more kinds of metal selected from the group consisting of Cu, Mn, Ag, and V and the zeolite ion-exchanged with one or more kinds of metal selected from the group consisting of Fe, Ti, Co, the weight ratio of the zeolite ion-exchanged of the region A on the central side to the region B on the peripheral side may be constant or continuously or discontinuously changed. When this weight ratio of the zeolite ion-exchanged is changed in the region A on the central side, the ratio of the zeolite ion-exchanged with one or more kinds of metal selected from the group consisting of Fe, Ti, and Co is preferably larger toward the center O. Furthermore, when this weight ratio of the zeolite ion-exchanged is changed in the region B on the peripheral side, the ratio of the zeolite ion-exchanged with one or more kinds of metal selected from the group consisting of Fe, Ti, and Co is preferably larger toward the periphery.

Note that this weight ratio of the zeolite ion-exchanged of the region A on the central side to the region B on the peripheral side can be obtained from the regions excluding the partition walls intersecting with the boundary line C in the regions A and B. This is because the zeolite may penetrate into the partition walls intersecting with the boundary line C.

In the region A on the central side, the weight ratio of the zeolite ion-exchanged with one or more kinds of metal selected from the group consisting of Fe, Ti, and Co relative to the total weight of the zeolite ion-exchanged with one or more kinds of metal selected from the group consisting of Cu, Mn, Ag, and V and the zeolite ion-exchanged with one or more kinds of metal selected from the group consisting of Fe, Ti, and Co is preferably in the range of about 0.80 through about 1.00 and more preferably in the range of about 0.90 through about 1.00. When this weight ratio is about 0.80 or greater, the zeolite in the region A on the central side is easily effectively used for the conversion of NOx.

In the region B on the peripheral side, the weight ratio of the zeolite ion-exchanged with one or more kinds of metal selected from the group consisting of Cu, Mn, Ag, and V relative to the total weight of the zeolite ion-exchanged with one or more kinds of metal selected from the group consisting of Cu, Mn, Ag, and V and the zeolite ion-exchanged with one or more kinds of metal selected from the group consisting of Fe, Ti, and Co is preferably in the range of about 0.80 through about 1.00 and more preferably in the range of about 0.90 through about 1.00. When this weight ratio is about 0.80 or greater, the zeolite in the region B on the peripheral side is easily effectively used for the conversion of NOx.

In the honeycomb unit 11, the content of zeolite per apparent volume is preferably in the range of about 230 through about 270 g/L. When the content of zeolite per apparent volume of the honeycomb unit 11 is about 230 g/L or greater, it is not necessary to increase the apparent volume of the honeycomb unit 11 so as to obtain a sufficient NOx conversion ratio. When the content of zeolite per apparent volume of the honeycomb unit 11 is about 270 g/L or less, the strength of the honeycomb unit 11 hardly becomes insufficient. Note that the zeolite represents the whole zeolite, i.e., the zeolite ion-exchanged and the zeolite not ion-exchanged.

Note that the apparent volume of the honeycomb unit represents a volume including the through-holes.

The ion-exchange amounts of the zeolite ion-exchanged with one or more kinds of metal selected from the group consisting of Cu, Mn, Ag, and V and the zeolite ion-exchanged with one or more kinds of metal selected from the group consisting of Fe, Ti, and Co are independently preferably in the range of about 1.0 through about 10.0% by weight and more preferably in the range of about 1.0 through about 5.0% by weight. When the ion-exchange amount is about 1.0% by weight or greater, variation in the adsorption performance of ammonia hardly becomes insufficient. When the ion-exchange amount is about 10.0% by weight or less, the honeycomb unit 11 hardly becomes structurally unstable where it is heated. Note that when the zeolite is ion-exchanged, it is impregnated with an aqueous solution containing a cation.

The zeolite is not particularly limited, but examples thereof include β zeolite, ZSM5 zeolite, mordenite, faujasite, zeolite A, zeolite L, and the like. Two or more of these substances may be used in combination. Note that the zeolite represents the whole zeolite.

In addition, the zeolite has a molar ratio of silica to alumina in the range of about 30 through about 50. Note that the zeolite represents the whole zeolite.

Furthermore, the zeolite preferably contains secondary particles, and the average particle diameter of the secondary particles of the zeolite is preferably in the range of about 0.5 through about 10 μm. When the average particle diameter of the secondary particles of the zeolite is about 0.5 μm or greater, it is not necessary to add a large amount of inorganic binders. As a result, extrusion molding of the honeycomb unit becomes easy. When the average particle diameter of the secondary particles of the zeolite is about 10 μm or less, the specific surface area of the zeolite in the honeycomb unit is hardly reduced. As a result, reduction in a NOx conversion ratio hardly occurs. Note that the zeolite represents the whole zeolite.

Moreover, in order to improve its strength, the honeycomb unit 11 may further contain inorganic particles other than the zeolite. The inorganic particles other than the zeolite are not particularly limited, but examples thereof include alumina, silica, titania, zirconia, ceria, mullite, precursors thereof, and the like. Two or more of these substances may be used in combination. Among these substances, alumina and zirconia are particularly preferable. Note that the zeolite represents the whole zeolite.

The average particle diameter of the inorganic particles other than the zeolite is preferably in the range of about 0.5 through about 10 μm. When this average particle diameter is about 0.5 μm or greater, it is not necessary to add a bunch of inorganic binders. As a result, extrusion molding of the honeycomb unit becomes easy. When this average particle diameter is about 10 μm or less, the effect of improving the strength of the honeycomb unit 11 hardly becomes insufficient. Note that the inorganic particles other than the zeolite may contain secondary particles.

Furthermore, the ratio of the average particle diameter of the secondary particles of inorganic particles other than the zeolite to the average particle diameter of the secondary particles of the zeolite is preferably about 1 or less and more preferably in the range of about 0.1 through about 1. When this ratio about 1 or less, the effect of improving the strength of the honeycomb unit 11 hardly becomes insufficient. Note that the zeolite represents the whole zeolite.

The content of the inorganic particles other than the zeolite in the honeycomb unit 11 is preferably in the range of about 3 through about 30% by weight and more preferably in the range of about 5 through about 20% by weight. When this content is about 3% by weight or greater, the effect of improving the strength of the honeycomb unit 11 hardly becomes insufficient. When this content is about 30% by weight or less, the content of the zeolite in the honeycomb unit 11 is hardly reduced. As a result, reduction in a NOx conversion ratio hardly occurs.

The inorganic binder is not particularly limited, but examples thereof include solid contents included in alumina sol, silica sol, titania sol, water glass, sepiolite, attapulgite, and the like. Two or more of these substances may be used in combination.

The content of the inorganic binder in the honeycomb unit 11 is preferably in the range of about 5 through about 30% by weight and more preferably in the range of about 10 through about 20% by weight. When the content of the inorganic binder is about 5% by weight or greater, the strength of the honeycomb unit 11 is hardly reduced. When the content of the inorganic binder is about 30% by weight or less, the molding of the honeycomb unit 11 hardly becomes difficult.

In order to improve its strength, the honeycomb unit 11 preferably contains inorganic fibers.

The inorganic fibers are not particularly limited so long as they are capable of improving the strength of the honeycomb unit 11, but examples thereof include alumina, silica, silicon carbide, silica alumina, glass, potassium titanate, aluminum borate, and the like. Two or more of these substances may be used in combination.

The aspect ratio of the inorganic fibers is preferably in the range of about 2 through about 1000, more preferably in the range of about 5 through about 800, and still more preferably in the range of about 10 through about 500. When the aspect ratio of the inorganic fibers is about 2 or greater, the effect of improving the strength of the honeycomb structure 11 is hardly reduced. When the aspect ratio of the inorganic fibers is about 1000 or less, clogging, etc., hardly occurs in a molding die at the molding of the honeycomb structure 11. In addition, when the honeycomb structure 11 is molded through extrusion molding, the inorganic fibers are broken, which hardly reduces the effect of improving the strength of the honeycomb unit 11.

The content of the inorganic fibers in the honeycomb unit 11 is preferably in the range of about 3 through about 50% by weight, more preferably in the range of about 3 through about 30% by weight, and still more preferably in the range of about 5 through about 20% by weight. When the content of the inorganic fibers is about 3% by weight or greater, the effect of improving the strength of the honeycomb unit 11 is hardly reduced. When the content of the inorganic fibers is about 50% or less, the content of the zeolite of the honeycomb unit 11 is hardly reduced. As a result, a NOx conversion ratio is hardly reduced.

The porosity of the honeycomb unit 11 is preferably in the range of about 25% through about 40%. When the porosity of the honeycomb unit is about 25% or greater, exhaust gases are easily likely to penetrate into the partition walls. As a result, the zeolite in the honeycomb unit 11 may be easily effectively used for the conversion of NOx. When the porosity of the honeycomb unit is about 40% or less, the strength of the honeycomb unit 11 hardly becomes insufficient.

The opening ratio of the cross section orthogonal to the longitudinal direction of the honeycomb unit 11 is preferably in the range of about 50 through about 65%. When the opening ratio of the honeycomb unit is about 50% or greater, the zeolite in the honeycomb unit 11 may be easily effectively used for the conversion of NOx. When the opening ratio of the honeycomb unit is about 65% or less, the strength of the honeycomb unit 11 hardly becomes insufficient.

The density of the through-holes 12 of the cross section orthogonal to the longitudinal direction of the honeycomb unit 11 is preferably in the range of about 31 through about 124 pieces/cm². When the density of the through-holes 12 of the honeycomb unit is about 31 pieces/cm² or greater, exhaust gases are easily likely to contact the zeolite. As a result, the NOx conversion performance of the honeycomb unit 11 is hardly reduced. When the density of the through-holes 12 of the honeycomb unit is about 124 pieces/cm² or less, the pressure loss of the honeycomb unit 11 is hardly increased.

The thickness of the partition walls partitioning the through-holes 12 of the honeycomb unit 11 is preferably in the range of about 0.10 through about 0.50 mm and more preferably in the range of about 0.15 through about 0.35 mm. When the thickness of the partition walls of the honeycomb unit is about 0.10 mm or greater, the strength of the honeycomb unit 11 is hardly reduced. When the thickness of the partition walls of the honeycomb unit is about 0.50 mm or less, exhaust gases are easily likely to penetrate into the partition walls. As a result, the zeolite is easily effectively used for the conversion of NOx.

The thickness of the peripheral coating layer 14 is preferably in the range of about 0.1 through about 2 mm. When the thickness of the peripheral coating layer 14 is about 0.1 mm or greater, the effect of improving the strength of the honeycomb structure 10 hardly becomes insufficient. When the thickness of the peripheral coating layer 14 is about 2 mm or less, the content of the zeolite per unit volume of the honeycomb structure 10 is hardly reduced. As a result, the NOx conversion performance of the honeycomb structure 10 is hardly reduced.

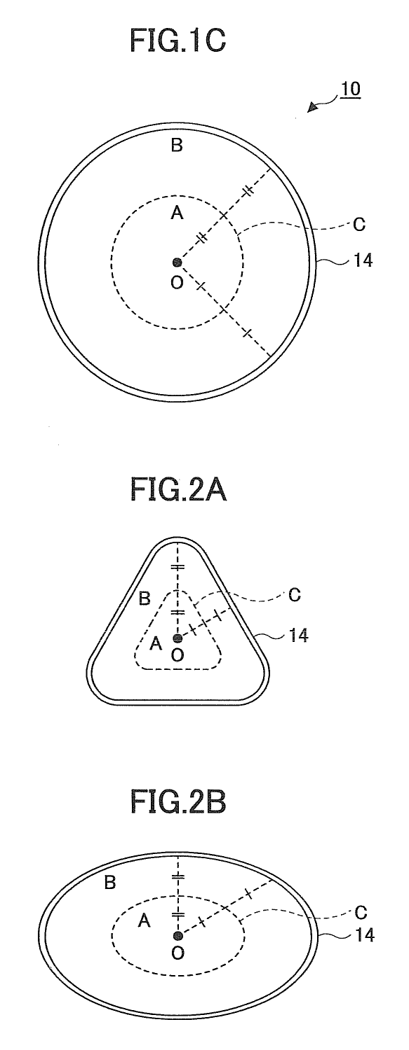

The honeycomb structure 10 is of a cylindrical shape. However, the shape of the honeycomb structure according to the embodiment of the present invention is not particularly limited, and examples thereof include a substantially triangular pillar shape (see FIG. 2A), a substantially cylindroid shape (see FIG. 2B), and the like.

Furthermore, the through-holes 12 are of a quadrangular pillar shape. However, the shape of the through-holes according to the embodiment of the present invention is not particularly limited, and examples thereof include a substantially triangular pillar shape, a substantially hexagonal pillar shape, and the like.

Next, an example of a method for manufacturing the honeycomb structure 10 is described. First, raw material pastes for the region A on the central side and the region B on the peripheral side, which contain the zeolite and the inorganic binder and further, as occasion demands, the inorganic particles other than the zeolite, the inorganic fibers, and the like, are subjected to double extrusion molding, thereby manufacturing a cylindrical-shaped raw honeycomb molded body in which the plural through-holes are arranged side by side through the partition walls. Accordingly, the cylindrical-shaped honeycomb unit 11 having sufficient strength can be obtained even at low firing temperature. Here, the paste for the region B on the peripheral side is larger than the paste for the region A on the central side in the weight ratio of the zeolite ion-exchanged with one or more kinds of metal selected from the group consisting of Cu, Mn, Ag, and V relative to the total weight of the zeolite ion-exchanged with one or more kinds of metal selected from the group consisting of Cu, Mn, Ag, and V and the zeolite ion-exchanged with one or more kinds of metal selected from the group consisting of Fe, Ti, and Co.

Note that the inorganic binder is added to the raw material pastes as alumina sol, silica sol, titania sol, water glass, sepiolite, attapulgite, and the like. Two or more of these substances may be used in combination.

Furthermore, an organic binder, a dispersion medium, a molding auxiliary agent, and the like may be added to the raw material pastes as occasion demands.

The organic binder is not particularly limited, but examples thereof include methyl cellulose, carboxymethyl cellulose, hydroxyethyl cellulose, polyethylene glycol, phenol resin, epoxy resin, and the like. Two or more of these substances may be used in combination. Note that the addition amount of the organic binder is preferably in the range of about 1 through about 10% relative to the total weight of the zeolite, the inorganic particles other than the zeolite, the inorganic fibers, and the inorganic binder. Note that the zeolite represents the whole zeolite.

The dispersion medium is not particularly limited, but examples thereof include water, organic solvents such as benzene, and alcohols such as methanol, and the like. Two or more of these substances may be used in combination.

The molding auxiliary agent is not particularly limited, but examples thereof include ethylene glycol, dextrin, fatty acid, fatty acid soap, polyalcohol, and the like. Two or more of these substances may be used in combination.

When the raw material pastes are prepared, they are preferably mixed and kneaded together. The raw material pastes may be mixed by a mixer, an attritor, and the like, and kneaded by a kneader, and the like.

Next, the honeycomb molded body thus obtained is dried with a drying apparatus such as a microwave drying apparatus, a hot-air drying apparatus, a dielectric drying apparatus, a pressures reduction drying apparatus, a vacuum drying apparatus, and a freeze drying apparatus.

Then, the obtained honeycomb molded body is degreased. Degreasing conditions are not particularly limited, but they can appropriately be selected according to the kinds and amounts of the organic matters contained in the molded body. However, the honeycomb molded body is preferably degreased at about 400° C. for about two hours.

Next, the honeycomb molded body is fired to obtain the cylindrical-shaped honeycomb unit 11. A firing temperature is preferably in the range of about 600 through about 1200° C. and more preferably in the range of about 600 through about 1000° C. When the firing temperature is about 600° C. or greater, sintering easily progresses. As a result, the strength of the honeycomb unit 11 is hardly reduced. When the firing temperature is about 1200° C. or less, the sintering does not excessively progress. As a result, the reaction sites of the zeolite in the honeycomb unit 11 is hardly reduced.

Then, the paste for the peripheral coating layer is coated on the peripheral surface of the cylindrical-shaped honeycomb unit 11. The paste for the peripheral coating layer is not particularly limited, but examples thereof include a mixture of the inorganic binder and the inorganic particles, a mixture of the inorganic binder and the inorganic fibers, a mixture of the inorganic binder, the inorganic particles, and the inorganic fibers, and the like.

Furthermore, the paste for the peripheral coating layer may contain the organic binder. The organic binder is not particularly limited, but examples thereof include polyvinyl alcohol, methyl cellulose, ethyl cellulose, carboxymethyl cellulose, and the like. Two or more of these substances may be used in combination.

Next, the honeycomb unit 11 after being coated with the paste for the peripheral coating layer is dried and solidified, thereby obtaining the cylindrical-shaped honeycomb structure 10. When the organic binder is contained in the paste for the peripheral coating layer, the honeycomb structure 10 is preferably degreased. The degreasing conditions may appropriately be determined according to the kinds and amounts of the organic matters contained in the peripheral coating layer, but the organic structure 10 is preferably degreased at about 700° C. for about 20 minutes.

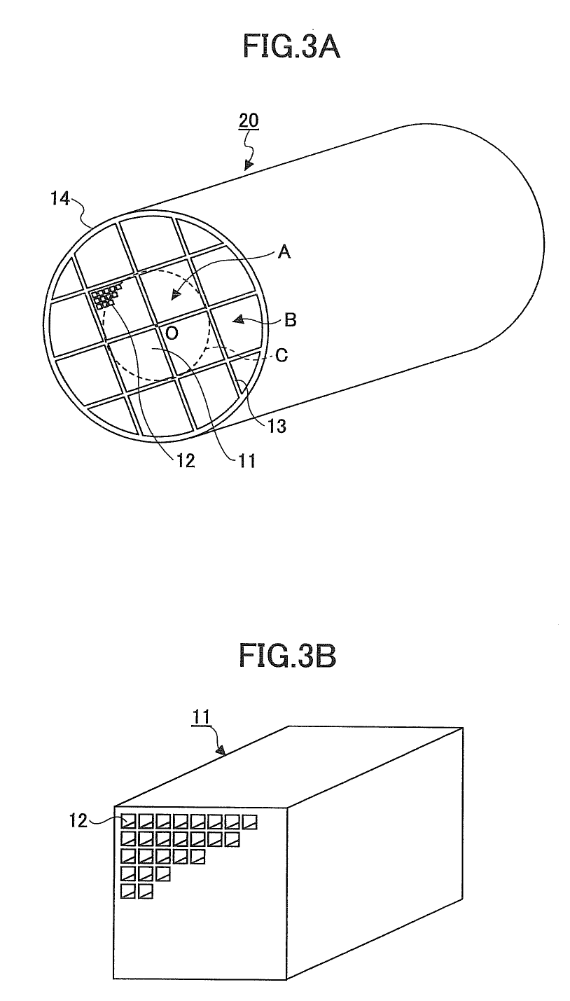

FIGS. 3A and 3B show other example of the honeycomb structure according to the embodiment of the present invention. Note that a honeycomb structure 20 is similar to the honeycomb structure 10 except that it has plural of the honeycomb units 11, in which the plural through-holes 12 are arranged side by side in the longitudinal direction through the partition walls, are bonded together by interposing an adhesive layer 13.

The cross section area of the cross section orthogonal to the longitudinal direction of the honeycomb unit 11 is preferably in the range of about 5 through about 50 cm². When the cross section area of the honeycomb unit is about 5 cm² or greater, the specific surface area of the honeycomb structure 10 is hardly reduced and the pressure loss thereof is hardly increased. When the cross section area of the honeycomb unit is 50 cm² or less, strength for the thermal stress caused in the honeycomb unit 11 hardly becomes insufficient.

The thickness of the adhesive layer 13 for bonding the honeycomb units 11 together is preferably in the range of about 0.5 through about 2 mm. When the thickness of the adhesive layer 13 is about 0.5 mm or greater, adhesive strength hardly becomes insufficient. On the other hand, when the thickness of the adhesive layer 13 is about 2 mm or less, the specific surface area of the honeycomb structure 10 is hardly reduced and the pressure loss thereof is hardly increased.

Furthermore, the honeycomb unit 11 is of a quadrangular pillar shape. Here, the shape of the honeycomb unit according to the embodiment of the present invention is not particularly limited, but it is preferably one such as a substantially hexagonal pillar that makes it easy to bond the honeycomb units together.

Next, an example of a method for manufacturing the honeycomb structure 20 is described. First, the quadrangular-pillar-shaped honeycomb units 11 are manufactured in the same manner as the honeycomb structure 10. At this time, the manufactured honeycomb units 11 include honeycomb units for the region A on the central side, honeycomb units for the region B on the peripheral side, and honeycomb units for the region including the boundary line C. The honeycomb units 11 for the region including the boundary line C can be manufactured by double extrusion molding using the material pastes for the regions A and B on the central and the peripheral sides. However, in the embodiment of the present invention, the honeycomb units 11 for the region A on the central side and/or the honeycomb units 11 for the region B on the peripheral side may be used for the region including the boundary line C.

Then, the paste for the adhesive layer is coated on the peripheral surfaces of the honeycomb units 11, and the honeycomb units 11 are bonded together one by one. The bonded honeycomb units 11 are dried and solidified to manufacture the aggregate of the honeycomb units 11. At this time, the aggregate of the honeycomb units 11 after being manufactured may be cut into a cylindrical shape and polished. Furthermore, the honeycomb units having a substantially sector-shaped or a substantially square-shaped cross sections may be bonded together to manufacture the aggregate of the cylindrical-shaped honeycomb units 11.

The paste for the adhesive layer is not particularly limited, but examples thereof include a mixture of the inorganic binder and the inorganic particles, a mixture of the inorganic binder and the inorganic fibers, a mixture of the inorganic binder, the inorganic particles, and the inorganic fibers, and the like.

Furthermore, the paste for the adhesive layer may contain an organic binder. The organic binder is not particularly limited, but examples thereof include polyvinyl alcohol, methyl cellulose, ethyl cellulose, carboxymethyl cellulose, and the like. Two or more of these substances may be used in combination.

Next, the paste for the peripheral coating layer is coated on the peripheral surface of the aggregate of the cylindrical-shaped honeycomb units 11. The paste for the peripheral coating layer is not particularly limited, but it may contain a material the same as or different from the material of the paste for the adhesive layer. Furthermore, the paste for the peripheral coating layer may have the same composition as the paste for the adhesive layer.

Then, the aggregate of the honeycomb units 11 on which the paste for the peripheral coating layer is coated is dried and solidified to obtain the cylindrical shaped honeycomb structure 20. When the organic binder is contained in the paste for the adhesive layer and/or the paste for the peripheral coating layer, the honeycomb structure 20 is preferably degreased. Degreasing conditions are not particularly limited, but they can appropriately be selected according to the kinds and amounts of the organic matters contained in the honeycomb structure 20. However, the honeycomb structure 20 is preferably degreased for about 20 minutes at about 700° C.

Note that the honeycomb structures 10 and 20 are manufactured in such a manner that a honeycomb structure using a material paste containing zeolite not ion-exchanged is first manufactured and then an aqueous solution containing a cation is applied in the central part and the peripheral part of the honeycomb structure to exchange the ion of the zeolite.

### EXAMPLES

### Example 1

First, 2250 g of β zeolite having an average particle diameter of 2 μm, a silica/alumina ratio of 40, and a specific surface area of 110 m²/g, 2600 g of alumina sol as an inorganic-binder-containing component having a solid content of 20% by weight, 550 g of γ-alumina as inorganic particles having an average particle diameter of 2 μm, 780 g of alumina fibers as inorganic fibers having an average fiber diameter of 6 μm and an average fiber length of 100 μm, and 410 g of methyl cellulose as an organic binder were mixed and kneaded together to obtain a raw material paste. Next, the raw material paste was extrusion-molded by an extrusion molding machine to obtain a cylindrical-shaped raw honeycomb molded body. Then, the honeycomb molded body was dried by a microwave drying apparatus and a hot-air drying apparatus and degreased at 400° C. for five hours. Next, the honeycomb molded body was fired at 700° C. for five hours to manufacture a cylindrical-shaped honeycomb unit having a diameter of 143 mm and a length of 150 mm. After that, an iron nitrate aqueous solution and a copper nitrate aqueous solution were applied in the central part and the peripheral part of the honeycomb unit separately several times to exchange the ions of the central part and the peripheral part of the honeycomb unit. The ion-exchange kinds of the zeolite in the region A on the central side and the zeolite in the region B on the peripheral side of the obtained honeycomb unit 11 were Fe and Cu, respectively, and the ion-exchange amount thereof was 3% by weight (see Table 1). Note that the ion-exchange amount was obtained through an IPC emission spectrometry using the ICPS-8100 (manufactured by Shimadzu Corporation). Furthermore, the boundary line C as the boundary between the region A on the central side and the region B on the peripheral side represents the circle positioned 71.5 mm away from the center O on the cross section orthogonal to the longitudinal direction of the honeycomb unit 11, and the ion-exchange amount was obtained from the partition walls that do not intersect with the boundary line C.

Furthermore, the obtained honeycomb unit 11 showed an opening ratio of 60%, a through-hole density of 78 pieces/cm², a partition wall thickness of 0.25 mm, a zeolite content of 250 g/L per apparent volume, and a porosity of 30% at the cross section orthogonal to the longitudinal direction.

Here, the opening ratio was obtained by calculating the areas of the through-holes in the region of a 10 cm square of the honeycomb structure with an optical microscope. Furthermore, the density of the through-holes was obtained by measuring the number of through-holes in the region of the 10 cm square of the honeycomb structure with the optical microscope. Moreover, the partition wall thickness was the average value obtained by measuring the thicknesses of the partition walls (at five areas) of the honeycomb structure with the optical microscope. Furthermore, the porosity was obtained by a mercury penetration method.

Next, 29 parts by weight of γ alumina as inorganic particles having an average particle diameter of 2 μm, 7 parts by weight of alumina fibers as inorganic fiber having an average fiber diameter of 6 μm and an average fiber length of 100 μm, 34 parts by weight of alumina sol as an inorganic-binder-containing component having a solid content of 20% by weight, 5 parts by weight of methyl cellulose as an organic binder, and 25 parts by weight of water were mixed and kneaded together to obtain a paste for the peripheral coating layer.

Moreover, the paste for the peripheral coating layer was coated on the peripheral surface of the honeycomb unit 11 so that the thickness of the peripheral coating layer 14 becomes 0.4 mm. After that, the honeycomb unit 11 was dried and solidified at 120° C. and degreased at 400° C. for two hours with a microwave drying apparatus and a hot-air drying apparatus to obtain the cylindrical-shaped honeycomb structure 10 having a diameter of 143.8 mm and a length of 150 mm.

### Example 2

The honeycomb structure 10 was manufactured in the same manner as Example 1 except that the ion-exchange kinds in the region A on the central side and the region B on the peripheral side were changed by the use of an aqueous solution containing iron nitrate and copper nitrate (see Table 1).

### Example 3

The honeycomb structure 10 was manufactured in the same manner as Example 1 except that the ion-exchange kinds in the region A on the central side and the region B on the peripheral side were changed by the use of an aqueous solution containing iron nitrate and silver nitrate (see Table 1).

### Example 4

The honeycomb structure 10 was manufactured in the same manner as Example 1 except that the ion-exchange kinds in the region A on the central side and the region B on the peripheral side were changed by the use of an aqueous solution containing iron nitrate and manganese nitrate (see Table 1).

### Example 5

The honeycomb structure 10 was manufactured in the same manner as Example 1 except that the ion-exchange kinds in the region A on the central side and the region B on the peripheral side were changed by the use of an aqueous solution containing iron nitrate and vanadium nitrate (see Table 1).

### Example 6

The honeycomb structure 10 was manufactured in the same manner as Example 1 except that the ion-exchange kinds in the region A on the central side and the region B on the peripheral side were changed by the use of an aqueous solution containing cobalt nitrate and copper nitrate (see Table 1).

### Example 7

The honeycomb structure 10 was manufactured in the same manner as Example 1 except that the ion-exchange kinds in the region A on the central side and the region B on the peripheral side were changed by the use of an aqueous solution containing titanium nitrate and copper nitrate (see Table 1).

### Example 8

The honeycomb structure 10 was manufactured in the same manner as Example 1 except that the ion-exchange kinds in the region A on the central side and the region B on the peripheral side were changed by the use of an aqueous solution containing iron nitrate and copper nitrate (see Table 1).

### Comparative Example 1

2250 g of β zeolite ion-exchanged with Fe by 3% by weight having an average particle diameter of 2 μm, a silica/alumina ratio of 40, and a specific surface area of 110 m²/g, 2600 g of alumina sol having a solid content of 20% by weight, 550 g of γ-alumina having an average particle diameter of 2 μm, 780 g of alumina fibers having an average fiber diameter of 6 μm and an average fiber length of 100 μm, and 410 g of methyl cellulose were mixed and kneaded together to obtain a raw material paste.

The honeycomb structure 10 was manufactured in the same manner as Example 1 using the obtained raw material paste except that the honeycomb unit was not ion-exchanged (see Table 1).

### Comparative Example 2

The honeycomb structure 10 was manufactured in the same manner as Comparative Example 1 except that the ion-exchange kind of zeolite was changed from Fe to Cu (see Table 1).

TABLE 1

| | REGION A ON | REGION B ON | NOx CONVERSION | |
|---|---|---|---|---|
| | CENTRAL SIDE | PERIPHERAL SIDE | RATIO (%) | |
| | ION-EXCHANGE KIND | ION-EXCHANGE KIND | 1500 rpm/ | 3000 rpm/ |
| | (WEIGHT RATIO) | (WEIGHT RATIO) | 40 N · m | 170 N · m |
| EXAMPLE 1 | Fe (100) | Cu(100) | 71 | 95 |
| EXAMPLE 2 | Fe/Cu(90/10) | Fe/Cu(10/90) | 71 | 95 |
| EXAMPLE 3 | Fe/Ag(90/10) | Fe/Ag(10/90) | 72 | 90 |
| EXAMPLE 4 | Fe/Mn(90/10) | Fe/Mn(10/90) | 70 | 90 |
| EXAMPLE 5 | Fe/V(90/10) | Fe/V(10/90) | 70 | 92 |
| EXAMPLE 6 | Co/Cu(90/10) | Co/Cu(10/90) | 70 | 92 |
| EXAMPLE 7 | Ti/Cu(90/10) | Ti/Cu(10/90) | 70 | 90 |
| EXAMPLE 8 | Fe/Cu(80/20) | Fe/Cu(20/80) | 69 | 92 |
| COMPARATIVE | Fe(100) | Fe(100) | 46 | 97 |
| EXAMPLE 1 | | | | |
| COMPARATIVE | Cu(100) | Cu(100) | 72 | 85 |
| EXAMPLE 2 | | | | |

Note that A/B (X/Y) of the ion-exchange kind (weight ratio) in the table represents that the weight ratio of A to B is X/Y.

(Measurement of NOx Conversion Ratio)

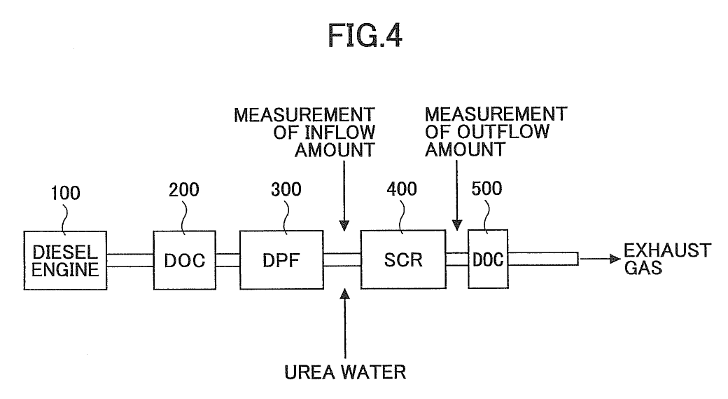

As shown in FIG. 4, a diesel engine (1.6 L direct-injection engine) 100 was operated under conditions that it had a rotation number of 1500 rpm and a torque of 40 N·m or a rotation number of 3000 rpm and a torque of 170 N·m while being connected in series to a diesel oxidation catalyst (DOC) 200, a diesel particulate filter (DPF) 300, a SCR 400, and a diesel oxidation catalyst (DOC) 500 via exhaust pipes. Urea water was injected to the exhaust pipe right before the SCR 400. At this time, the inflow and outflow amounts of nitrogen monoxide (NO) and nitrogen dioxide (NO₂) to and from the SCR 400 were measured by the MEXA-7500DEGR (manufactured by HORIBA, Ltd.), and the NOx conversion ratio (%) represented by the formula “(NOx inflow amount−NOx outflow amount)/(NOx inflow amount)×100” was measured (detection limit: 0.1 ppm). Note that as the DOC 200, the DPC 300, the SCR 400, and the DOC 500, a honeycomb structure having a diameter of 143.8 mm and a length of 7.35 mm (commercialized product), a honeycomb structure having a diameter of 143.8 mm and a length of 152.4 mm (commercialized product), the honeycomb structures described in Examples 1 through 8 or Comparative Example 1 and 2, and a honeycomb structure having a diameter of 143.8 mm and a length of 50.8 mm (commercialized product), each of which is accommodated in a metal container (shell) and has a holding sealing member (mat) at its periphery, are used, respectively. Measurement results are shown in Table 1. It is clear from Table 1 that the honeycomb structures shown in Examples 1 through 8 are superior to the honeycomb structures shown in Comparative Examples 1 and 2 in a NOx conversion ratio in a wide temperature range.

As described above, the NOx conversion ratio of the honeycomb structure 10 can be improved in a wide temperature range, provided that, when the cross section orthogonal to the longitudinal direction of the honeycomb structure 10 is divided into two equal parts at even intervals between the periphery and the center O of the cross section, the region B on the peripheral side is larger than the region A on the central side in the weight ratio of the zeolite ion-exchanged with one or more kinds of metal selected from the group consisting of Cu, Mn, Ag, and V relative to the total weight of the zeolite ion-exchanged with one or more kinds of metal selected from the group consisting of Cu, Mn, Ag, and V and the zeolite ion-exchanged with one or more kinds of metal selected from the group consisting of Fe, Ti, and Co, and the region A on the central side is larger than the region B on the peripheral side in the weight ratio of the zeolite ion-exchanged with one or more kinds of metal selected from the group consisting of Fe, Ti, and Co relative to the total weight of the zeolite ion-exchanged with one or more kinds of metal selected from the group consisting of Cu, Mn, Ag, and V and the zeolite ion-exchanged with one or more kinds of metal selected from the group consisting of Fe, Ti, and Co.

The present invention is not limited to the specifically disclosed embodiment, but variations and modifications may be made without departing from the scope of the present invention.

Obviously, numerous modifications and variations of the present invention are possible in light of the above teachings. It is therefore to be understood that within the scope of the appended claims, the invention may be practiced otherwise than as specifically described herein.

What is claimed is:

1. A honeycomb structure comprising:
at least one honeycomb unit having a longitudinal direction and including walls extending along the longitudinal direction to define through-holes;
a center region having a smaller similarity shape in relation to a peripheral shape of the honeycomb structure in a cross section perpendicular to the longitudinal direction, the smaller similarity shape being defined by including a center of the honeycomb structure and substantially a half of a length from the center to the peripheral shape of the honeycomb structure;
a peripheral region located outside the smaller similarity shape;
an inorganic binder;
zeolite ion-exchanged with at least one of Cu, Mn, Ag, and V at a first weight ratio and at a second weight ratio in the center region and in the peripheral region, respectively, relative to a total weight of the zeolite, the second weight ratio being larger than the first weight ratio; and
zeolite ion-exchanged with at least one of Fe, Ti, and Co at a third weight ratio and at a fourth weight ratio in the center region and in the peripheral region, respectively, relative to a total weight of the zeolite, the third weight ratio being larger than the fourth weight ratio.

2. The honeycomb structure according to claim 1, wherein the second weight ratio of the zeolite ion-exchanged with at least one of Cu, Mn, Ag, and V is in a range of about 0.80 to about 1.00.

3. The honeycomb structure according to claim 1, wherein the third weight ratio of the zeolite ion-exchanged with at least one of Fe, Ti, and Co is in a range of about 0.80 to about 1.00.

4. The honeycomb structure according to claim 1, wherein a content of the zeolite per apparent volume of the at least one honeycomb unit is in a range of about 230 g/L to about 270 g/L.

5. The honeycomb structure according to claim 1, wherein the zeolite comprises at least one of β zeolite, Y zeolite, ferrierite, ZSM5 zeolite, mordenite, faujasite, zeolite A, and zeolite L.

6. The honeycomb structure according to claim 1, wherein the zeolite has a molar ratio of silica to alumina in a range of about 30 to about 50.

7. The honeycomb structure according to claim 1, wherein the zeolite comprises secondary particles having an average particle diameter in a range of about 0.5 μm to about 10 μm.

8. The honeycomb structure according to claim 1, further comprising inorganic particles other than zeolite.

9. The honeycomb structure according to claim 8, wherein the inorganic particles other than zeolite comprise at least one of alumina, silica, titania, zirconia, ceria, mullite, and precursors thereof.

10. The honeycomb structure according to claim 1, wherein the inorganic binder is a solid content comprising at least one of alumina sol, silica sol, titania sol, water glass, sepiolite, and attapulgite.

11. The honeycomb structure according to claim 1, further comprising inorganic fibers.

12. The honeycomb structure according to claim 11, wherein the inorganic fibers comprise at least one of alumina, silica, silicon carbide, silica alumina, glass, potassium titanate, and aluminum borate.

13. The honeycomb structure according to claim 1, wherein a porosity of the at least one honeycomb unit is in a range of about 25% to about 40%.

14. The honeycomb structure according to claim 1, wherein an opening ratio in the cross section of the at least one honeycomb unit is in a range of about 50% to about 65%.

15. The honeycomb structure according to claim 1, wherein a density of the through-holes in the cross section of the at least one honeycomb unit is in a range of about 31 pieces/cm² to about 124 pieces/cm².

16. The honeycomb structure according to claim 1, wherein the at least one honeycomb unit comprises plural honeycomb units bonded together by interposing an adhesive layer.

17. The honeycomb structure according to claim 1, the at least one honeycomb unit comprises a single honeycomb unit.

18. The honeycomb structure according to claim 1, further comprising a peripheral coating layer provided on a peripheral surface of the honeycomb structure.

19. The honeycomb structure according to claim 1, wherein each of the first weight ratio within the central region, the third weight ratio within the central region, the second weight ratio within the peripheral region, and the fourth weight ratio within the peripheral region is substantially constant.

20. The honeycomb structure according to claim 1, wherein at least one of the first weight ratio within the central region, the third weight ratio within the central region, the second weight ratio within the peripheral region, and the fourth weight ratio within the peripheral region is continuously or discontinuously changed.

21. The honeycomb structure according to claim 20, wherein the first and third weight ratios of the zeolite within the central region are changed in a direction orthogonal to the longitudinal direction, the third weight ratio of the zeolite ion-exchanged with at least one one of Fe, Ti, and Co increasing toward the center.

22. The honeycomb structure according to claim 20, wherein the second and fourth weight ratios of the zeolite within the peripheral region are changed in a direction orthogonal to the longitudinal direction, the fourth ratio of the zeolite ion-exchanged with at least one of Fe, Ti, and Co increasing toward the peripheral shape.

23. The honeycomb structure according to claim 1, wherein each of the zeolite ion-exchanged with at least one of Cu, Mn, Ag, and V and the zeolite ion-exchanged with at least one of Fe. Ti, and Co has an ion-exchange amount in a range of about 1.0% to about 10.0% by weight.

24. The honeycomb structure according to claim 8, wherein an average particle diameter of the inorganic particles other than zeolite is in a range of about 0.5 μm to about 10 μm.

25. The honeycomb structure according to claim 8, wherein a ratio of an average particle diameter of secondary particles of the inorganic particles other than zeolite to an average particle diameter of secondary particles of the zeolite is about 1 or less.

26. The honeycomb structure according to claim 8, wherein a content of the inorganic particles other than zeolite is in a range of about 3% to about 30% by weight.

27. The honeycomb structure according to claim 1i wherein a content of the inorganic binder in the at least one honeycomb unit is in a range of about 5% to about 30% by weight.

28. The honeycomb structure according to claim 11, wherein an aspect ratio of the inorganic fibers is in a range of about 2 to about 1000.

29. The honeycomb structure according to claim 11, wherein a content of the inorganic fibers in the at least one honeycomb unit is in a range of about 3% to about 50% by weight.

30. The honeycomb structure according to claim 1, wherein a thickness of the walls is in a range of about 0.10 mm to about 0.50 mm.

31. The honeycomb structure according to claim 1, wherein the at least one honeycomb unit is manufactured by being fired at a firing temperature in a range of about 600° C. to about 1200° C.

32. The honeycomb structure according to claim 16, wherein a cross section area of the cross section perpendicular to the longitudinal direction of the at least one honeycomb unit is in a range of about 5 cm² to about 50 cm².

33. The honeycomb structure according to claim 16, wherein the honeycomb structure is manufactured by cutting a peripheral part of the plural honeycomb units to form the peripheral shape of the honeycomb structure.

34. The honeycomb structure according to claim 16, wherein the honeycomb structure is manufactured by bonding the plural honeycomb units including at least one of a substantially sector-shaped honeycomb unit and a substantially square-shaped honeycomb unit in the cross section.

35. The honeycomb structure according to claim 1, wherein the honeycomb structure is so constructed to be used for a SCR system.
